(19) United States
(12) Patent Application Publication
(10) Pub. No.: US 2022/0326032 A1
(43) Pub. Date: Oct. 13, 2022

(54) SYSTEMS AND METHODS OF SIMULATING FLEET SERVICES BASED ON HISTORICAL INFORMATION

(71) Applicant: GoBrands, Inc., Philadelphia, PA (US)

(72) Inventor: Somchaya Liemhetcharat, Fremont, CA (US)

(73) Assignee: GoBrands, Inc., Philadelphia, PA (US)

(21) Appl. No.: 17/714,297

(22) Filed: Apr. 6, 2022

Related U.S. Application Data
(60) Provisional application No. 63/171,969, filed on Apr. 7, 2021.

(51) Int. Cl. G01C 21/36; G01C 21/34

(52) U.S. Cl. CPC G01C 21/3617; G01C 21/3492; G01C 21/3484

(57) ABSTRACT

A method includes obtaining historical information for a plurality of past trips that are completed by a fleet of vehicles. The historical information includes request times, origins, and destinations corresponding to the plurality of past trips completed by the fleet of vehicles. The method also includes generating a scenario based on the historical information, and performing a simulation based on the scenario. The simulation includes applying a first dispatching service and a first routing service to the scenario. The method further includes using the simulation to compare the first dispatching service to a second dispatching service and providing the comparison to a user.

### TECHNICAL FIELD

The disclosed embodiments relate generally to systems and methods for generating simulations for fleet-based transportation services based on historical information.

### BACKGROUND

Efficient dispatching and routing of vehicles is important in operation and management of a fleet of vehicles. Efficient and effective dispatching and routing can lead to reduced wait times for passengers, increased vehicle utilization rates, and an overall improvement in user and driver satisfaction. Evaluating a dispatching and/or routing service, including comparing two or more dispatching and/or routing services (or two different versions of a dispatching and/or routing service) based on their real-world performance can pose a challenge since there are no controls for replicating a scenario or for generating a controlled (e.g., baseline) scenario that can provide an apples-to-apples comparison between two dispatching and/or routing services.

### SUMMARY

Simulations can be a useful tool in assessing the effectiveness of a routing and/or dispatching service associated with a fleet of vehicles. Simulations can also provide baseline scenarios that lead to an apples-to-apples comparison of the performance between different fleet services (such as dispatching and/or routing services). For example, when implementing a new dispatching and/or routing service or implementing an update (e.g., a new version) to an existing dispatching and/or routing service, it may be desirable to perform one or more simulations as part of alpha-testing. Simulations allow for an apples-to-apples comparison between two different dispatching and/or routing services (or two different versions of a dispatching and/or routing service, such as an old version and a new version). Additionally, simulations improve the process of testing and implementing a new (or an updated) dispatching and/or routing service by allowing results to be performed and analyzed via computer simulation, as opposed to physically performing a test in the real world. Using simulations in alpha-testing can result in significant improvements in alpha-testing methods, including providing a more cost effective testing method, reducing wear and tear on fleets (e.g., wear and tear on vehicle components such as wheels, engines, brakes, etc.), and being more environmentally friendly (e.g., reduced emissions, reduced fuel consumption) compared to a real-world test.

The systems and methods described herein may be used as an analytical tool for evaluating the performance of a dispatching and/or routing service, as well as to provide a comparison between two dispatching and/or routing services (e.g., two different dispatching and/or routing services, or two versions of a same dispatching and/or routing service). The systems and methods described herein may also be used to attract a new fleet of vehicles to adopt a new dispatching and/or routing service.

In some embodiments, a computer system generates a scenario based on historical information that includes a plurality of past trips (e.g., completed trips). The computer system then applies a dispatching service and a routing service to the generated scenario that includes a plurality of trip requests that are generated based on the historical information, thereby simulating how the dispatching service and routing service would dispatch and route vehicles of a fleet to handle and complete the trip requests. The computer system generates metrics for evaluating the performance of the dispatching service and the routing service. The simulation results can be compared to information regarding the past trips (e.g., the past trips that are provided as historical information) as well as to results from other simulations where a different dispatching service and/or a different routing service is applied to the same scenario.

To that end, in accordance with some embodiments, a method includes obtaining historical information for a plurality of past trips that are completed by a fleet of vehicles. The historical information includes request times, origins, and destinations corresponding to the plurality of past trips completed by the fleet of vehicles. The method also includes generating a scenario based on the historical information, and performing a simulation based on the scenario, including applying a first dispatching service and a first routing service to the scenario. The method further includes using the simulation to compare the first dispatching service to a second dispatching service and providing the comparison to a user.

Some embodiments of the present disclosure provide a computer system (e.g., a server system), comprising one or more processors and memory storing one or more programs. The one or more programs store instructions that, when executed by the one or more processors, cause the computer system to perform any of the methods described herein.

Some embodiments of the present disclosure provide a computer program product (e.g., a non-transitory computer readable storage medium) storing instructions that, when executed by a computer system having one or more processors, cause the computer system to perform any of the methods described herein.

These embodiments improve evaluation of dispatching and/or routing services and can be used to improve dispatching and/or routing services, e.g., by improving the process of alpha testing new routing services. Thus, such embodiments may improve overall operation and management for the fleet of vehicles by providing a method for evaluating dispatching and/or routing services, thereby improving the efficiency of vehicle dispatching and increasing vehicle utilization rates.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings.

FIG. 1A-1B are block diagrams illustrating an architecture of a simulator, in accordance with some embodiments.

FIG. 1C is an example of a simulation result, in accordance with some embodiments.

FIGS. 2A-2G are examples of simulation results, in accordance with some embodiments.

FIGS. 3A-3B are block diagrams illustrating an architecture of a vehicle routing engine, in accordance with some embodiments.

FIG. 4 is a block diagram illustrating a client-server environment, in accordance with some embodiments.

FIGS. 5A-5D illustrate examples of historical information, in accordance with some embodiments.

FIGS. 6A-6B illustrate a flowchart of a method for simulating fleet services based on historical information, in accordance with some embodiments.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

It should be noted that various examples are described herein with respect to fleets of autonomous vehicles (AVs) and or mixed fleets of vehicles (e.g., with both autonomous vehicles, and human-driven vehicles). One of skill in the art, however, will recognize that the embodiments of the present disclosure are applicable to fleets of any type, whether fully autonomous, fully human-driven, or some combination. Moreover, the embodiments of the present disclosure may be applied to street-based vehicles, sidewalk robots, or any other type of appropriate vehicle.

Similarly, various examples provided herein describe on-demand services. One of skill in the art will recognize that the embodiments of the present disclosure apply with equal force to other types of fleet services, including scheduled services.

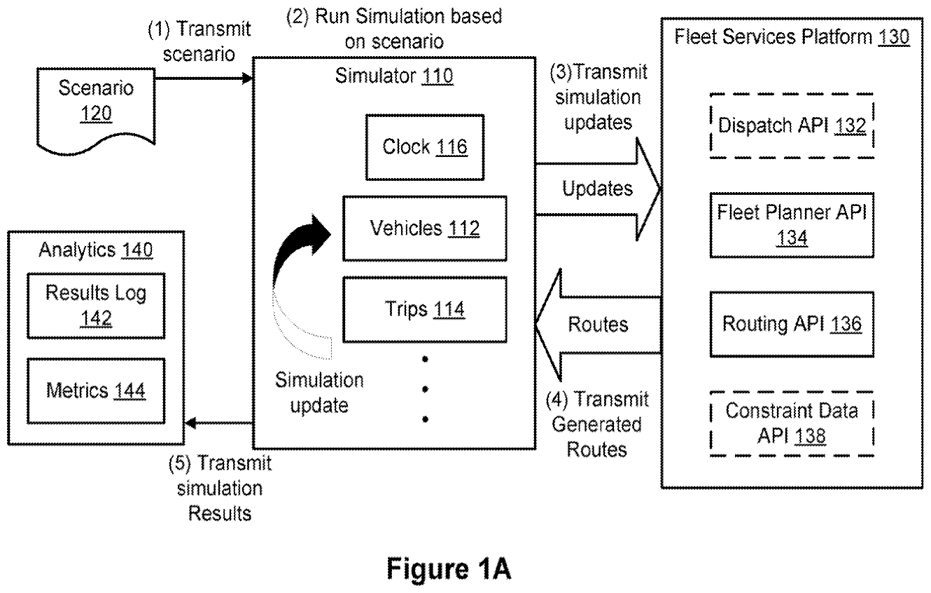

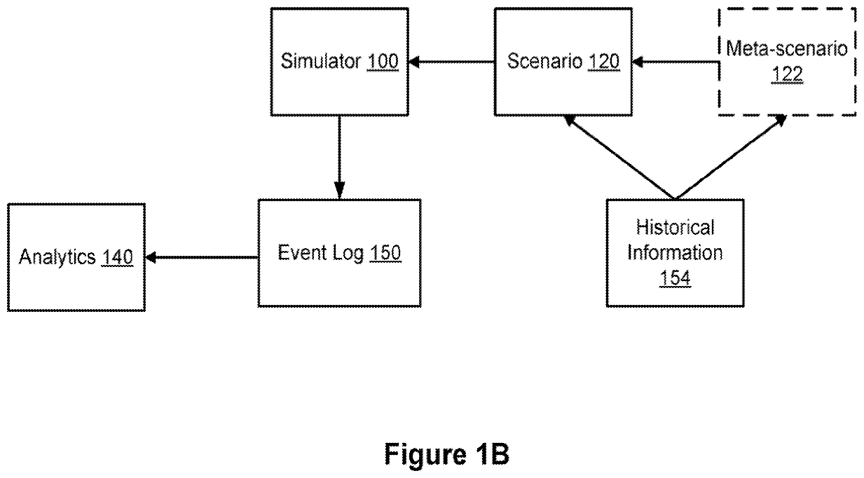

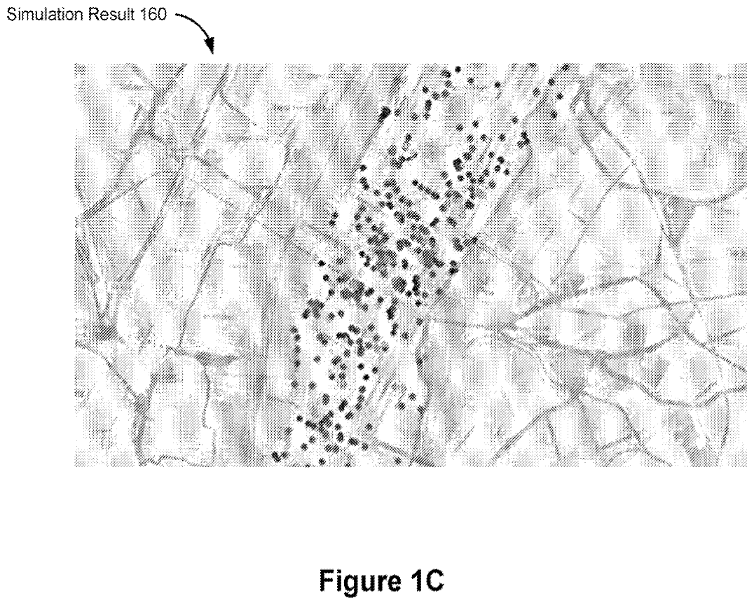

FIGS. 1A-1B are block diagrams illustrating an architecture of a simulator 110, in accordance with some embodiments.

FIG. 1A illustrates a simulator 110 for generating simulations for fleet services. The simulator 110 receives (step 1) a scenario 120 that includes information regarding trip requests. In some embodiments, the scenario 120 is generated from historical information that includes a plurality of past trips that are completed by a fleet of vehicles (e.g., real trips that were completed in the past by the fleet of vehicles). In step 2, the simulator 110 performs a simulation based on the received scenario 120. The simulator 110 utilizes information regarding vehicles 112 (e.g., vehicle locations, vehicle online/offline times, vehicle availability) and trips 114 (e.g., and their corresponding trip requests) that are provided by the scenario 120 to generate a simulation. For example, as part of the simulation, a scenario 120 provides (e.g., defines, includes) a plurality of trip requests to be completed by a fleet of vehicles. The simulator 110 also includes a clock 116 (e.g., simulation clock 116) which corresponds to a time of the simulation. For example, the real-world time may be Feb. 1, 2021 at 10:35 am and the simulation may be running a simulation based on a scenario 120 generated from historical information obtained from Jan. 4, 2021 between 1 pm and 4 pm. Thus, the simulation clock 116 has a time that corresponds to a time of the simulation (e.g., Jan. 4, 2021 at 1:35 pm) and not to the real-world time (e.g., Feb. 1, 2021 at 10:35 am). In some cases, the simulation clock 116 may have a same time as the real-world time. In step 3, the simulator 110 generates and provides a plurality of trip requests to a fleet services platform 130 (e.g., the simulation uses the fleet services platform 130 for generating dispatching and routing decisions). The simulator 110 is in communication with the fleet services platform 130, and the fleet services platform 130 may include any of an optional dispatch application programming interface (API) 132 (e.g., an application programming interface for a first dispatching service), a fleet planner API 134, a routing API 136 (e.g., an application programming interface for a first routing service), and an optional constraint data API 138. The fleet services platform 130 utilizes a first dispatching service (e.g., a dispatching service associated with the dispatch API 132) and a first routing service (e.g., a routing service associated with the routing API 136) to dispatch and route vehicles for completing trip requests in the simulation (e.g., trip requests as defined or provided by the scenario 120). In some embodiments, the fleet services platform 130 is the same fleet services platform that serviced the plurality of trips from which the historical information used to generate the scenario 120 is obtained. In some embodiments, the fleet services platform 130 is different from the fleet services platform that serviced the plurality of trips from which the historical information used to generate the scenario 120 is obtained (e.g., the historical information corresponds to a plurality of historical trips that were dispatched and routed by a different dispatching and routing service). The second dispatching service may be the same or different from the first dispatching service, and the second routing service may be the same or different from the first routing service. In most cases, the second dispatching service is different from the first dispatching service and/or the second routing service is different from the first routing service.

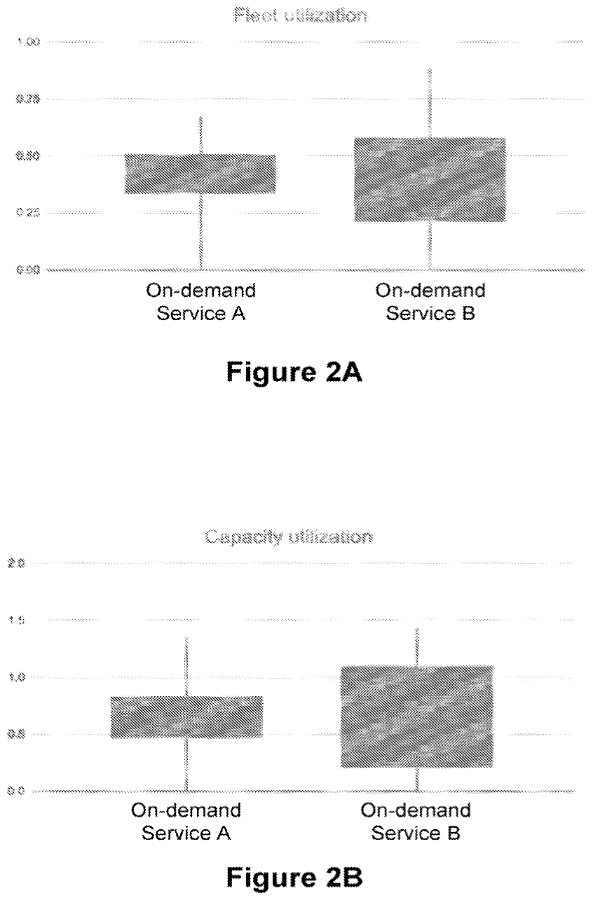

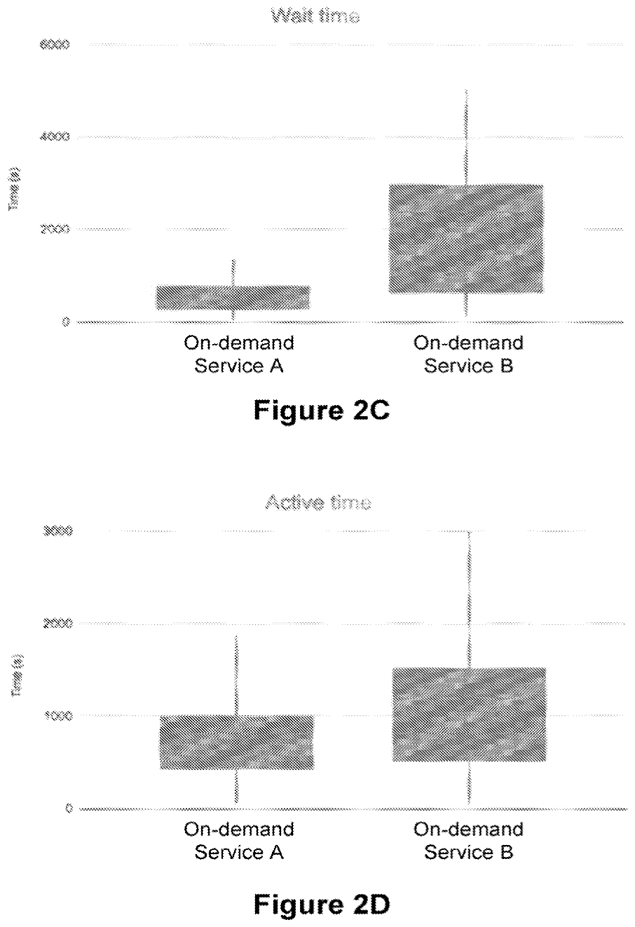

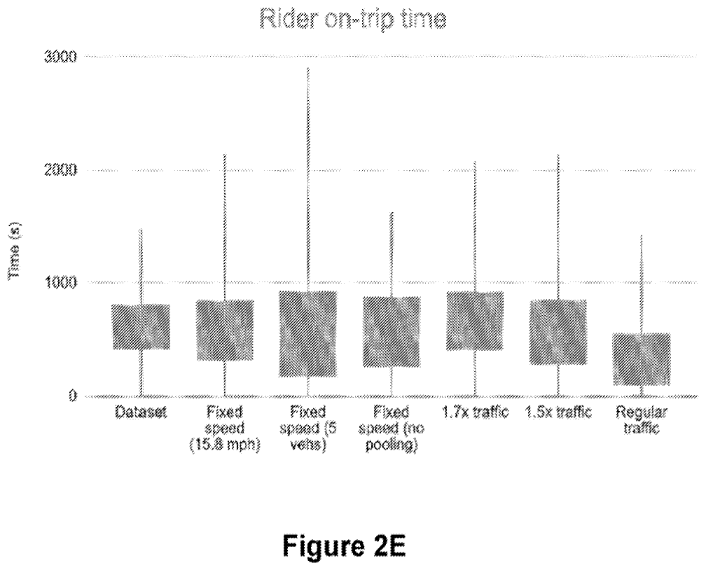

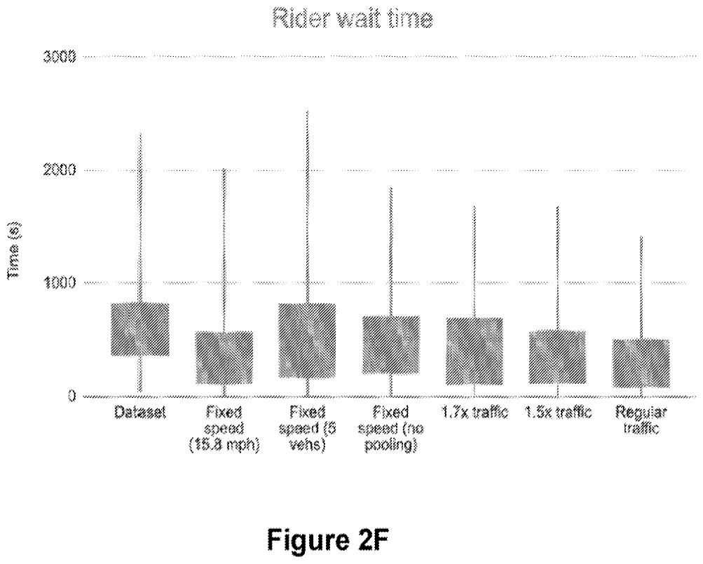

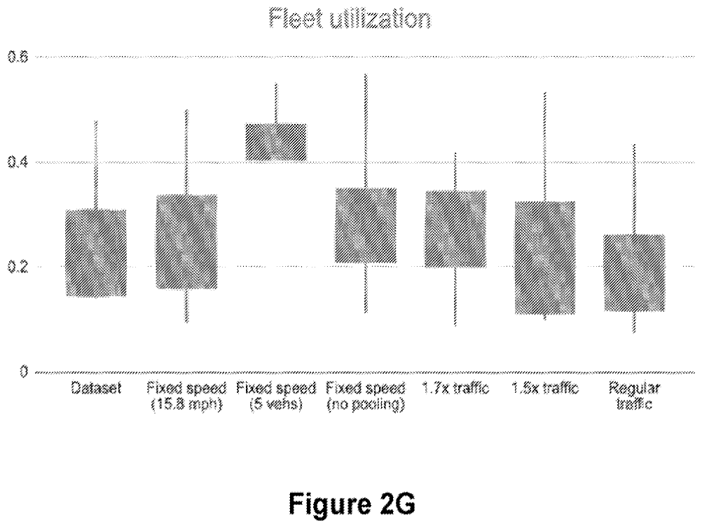

Performing the simulation includes providing the plurality of trip requests from the scenario 120 to the fleet services platform 130. The fleet services platform 130 generates dispatching information, trip plans, and trip routes for the plurality of trip requests from the scenario 120. In step 4, the fleet services platform 130 transmits the generated dispatching information, trip plans, and trip routes to the simulator 110. This process is repeated (e.g., iterated, continuously repeated) until the end of the simulation (e.g., once all trip requests of the plurality of trip requests from the scenario 120 are completed in the simulation). Once the simulation is completed, the simulation results are transmitted for analysis. Analysis of the simulation results produces an event log 150, from which analytics 140 may be generated. Analytics 140 may include a results log 142 that is generated based on the simulation results. The results log 142 may include information such as changes in status of vehicles, changes in status of riders, changes in status of trips, and/or information regarding the simulated trips (e.g., time of arrival for each trip, estimated time of arrival for each trip). The analytics 140 may also include metric(s) 144 that are generated based on the simulation results. For example, the metric(s) 144 may include metrics such as vehicle utilization rate and rider wait time. In some embodiments, the metric(s) 144 are generated based on information from the results log 142. Examples of analytics 140 that are generated from simulation results are provided below with respect to FIGS. 2A-2G.

Each simulation includes core objects (also referred to herein as core entities). The core objects include plans, riders, routes, trips, and vehicles. Each of the core objects are assigned a unique identifier such that no two core objects have a same identifier (e.g., “A123” refers to a specific rider and there are no routes that use the identifier “A123.” Each core object is associated with a state. For example, each vehicle in the simulation has an associated vehicle state. In general, an identifier and a state of a core object is stored together. For example, a trip core object includes an identifier for the trip (e.g., “T123”) and a state for the trip (e.g., “completed”).

FIG. 1B illustrates how a scenario 120 is used by the simulator 110 in generating simulations. Historical information 154 is used to generate a scenario 120 or to generate a meta-scenario 122. In some embodiments, historical information 154 is received in the form of an event log (e.g., a standardized format that is the same as the format used for the output of the simulator 100, shown as event log 150). In some embodiments, when the historical information 154 includes complete information, the historical information can be used to generate a scenario 120 that includes specific details regarding trip requests, such as specific pick-up locations and specific drop-oft locations, and specific trip request times (or specific scheduled trip times or requested pick-up times). In some embodiments, such as when the historical information 154 includes incomplete or abbreviated information (e.g., includes constraints or information regarding pick-up zones and drop-off zones) the historical information 154 is used to generate a meta-scenario 122 that includes information regarding simulation boundaries in which a scenario can be created. The historical information 154 may include incomplete or abbreviated information in order to comply with consumer privacy constraints that censor (e.g., remove, scrub, sanitize) specific details regarding each trip. For example, consumer privacy constraints may result in the historical information 154 including a zip code or a region indicator (e.g., zone A) instead of a specific pick up location, such as an address or global positioning system (GPS) coordinates. In another example, consumer privacy constraints may result in the historical information 154 including a time frame over which a plurality of trips are completed, or a plurality of trip requests are received, instead of providing specific times at which each trip request is received or each trip is completed.

For example, a meta-scenario 122 may include a geo-fence corresponding to an area over which the fleet of vehicles may operate, a number of available vehicles, meta positions for pick-up and drop-off locations (e.g., zone 1, zip code 93087, city of Cupertino), a number of trips (e.g., 172 trip requests), and a time period (e.g., 3 hours, between 9 am-5 pm). A meta-scenario may include meta-positions (e.g., fixed position(s), position(s) that are distributed over a bounding box, position(s) that are distributed over a circle, position(s) that are distributed over a geofence), meta-time (e.g. meta-duration, which can be any of: fixed time(s), time(s) that are distributed over a time interval, time(s) that are evenly spaced over a time interval), meta-integers (e.g., fixed value(s), value(s) that are distributed over a range of values). For example, a new trip in a meta-scenario 122 may include a meta-position for the origin, a meta-position for the destination, a meta-time for the trip creation time (e.g., trip request time), and a meta-integer for the number of trips. In another example, vehicle creation in a meta-scenario 122 may include a meta-position as the initial vehicle position (e.g., vehicle online position), a meta-time for the vehicle creation time (e.g., vehicle online time), a meta-duration for the service duration (e.g., how long the vehicle is active or online for), and a meta-integer for the number of vehicles.

The information defined in the meta-scenario 122 is used to generate the scenario 120, which includes fully specified information for each available vehicle 112 (e.g., vehicle status, vehicle online/offline time, vehicle location, vehicle online location) and each trip request (corresponding to trips 114). For example, a scenario 120 will include information regarding a vehicle's position, a vehicle's creation time and location (e.g., time and location at which the vehicle becomes available, comes “online”), a trip request's pick-up location (e.g., exact position), a trip request's drop-off location (e.g., exact position), and a trip request time (e.g., exact time the trip request was received). Thus, a plurality (potentially an infinite number) of different scenarios 120 can be created from one meta-scenario 122. Additionally, a meta-scenario 122 can be used to generate a deterministic sequence of scenarios 120.

In some embodiments, such as when a scenario 120 is generated from (e.g., based on, in accordance with) complete historical information 154, the scenario 120 can be generated by directly using (e.g., importing, replicating, copying) information and details regarding vehicles and trips from the historical information 154. In some cases, generating the scenario 120 directly from information and details regarding vehicles and trips from the historical information 154 includes removing information associated with dispatching and routing information (e.g., dispatching and routing decisions), such as dispatched vehicle identifier, vehicle dispatch time, trip route, estimated time of arrival, actual time of arrival. Thus, in some embodiments, the generated scenario includes information on trip requests but not information on how the trips were actually completed (as this information is what will be simulated).

In some embodiments, such as when a scenario 120 is generated from a meta-scenario 122, information regarding trips and defined boundaries and conditions from information in the meta-scenario 122 is used to generate specific vehicle information and specific trip details in the scenario 120. Thus, in some embodiments, the trip details generated from the meta-scenario are “back-filled,” meaning that the trip details for the simulation are not the same as the trip details for the actual historical trips (because such details were censored for privacy reasons). Rather, the “back-filled” trip details are dummy data, which, in some embodiments, are selected for statistical consistency with the actual historical trips.

In some embodiments, the simulator 110 includes one or more adaptors that allows historical trip data to be simulated using an fleet services platform 130 or an API associated with the fleet services platform 130, such as a fleet dispatching service (e.g., dispatch API 132) used by the fleet services platform 130 or a routing service (e.g., routing API 136, a routing service provided by a routing engine) used by the fleet services platform 130. In some embodiments, the simulator 110 includes one or more adaptors that allow historical information from a consumer (e.g., a partner) to be received and ingested to generate a scenario 120. The historical information from the consumer can be in any format and the adapter is able to convert the received historical information into a format that can be understood and used to generate a scenario 120 and/or to generate analytics 140. The use of adapters provides flexibility in operating the simulator 110 as historical data from various consumers and dispatching and routing services from various fleet services can simply be plugged into the simulator 110 via the use of adapters. Thus, when introducing a new consumer or a new fleet service to be connected to the simulator 110, a user can use an existing adaptor or generate a new adaptor that allows the simulator to communicate with the new consumer or new fleet service (e.g., without changing or manipulating the information or format of information transmitted between the consumer, fleet service, and simulator 110).

FIG. 1C is an example of a simulation result 160, in accordance with some embodiments. The simulation result 160 shown in FIG. 1C is a snapshot in time of a video of the simulation. Each of the dots corresponds to a vehicle of a fleet. A status of the vehicle is represented by the color of the dot. For example, a green dot indicates a vehicle that is available to be assigned to a trip request, a blue dot indicates a vehicle that has been assigned to a trip and is en route to the pick-up location (e.g., passenger not on board), and a red dot corresponds to a vehicle that is assigned to a trip and is en route to the drop-off location (e.g., passenger is on board). The simulation runs for a length of time as indicated by the scenario 120 used to generate the simulation (e.g., until all trip requests in the scenario 120 are completed), and the simulation shows updated positions of the vehicles (e.g., shows movement of the vehicles) during the simulation time. The simulation results can be used to generate a results log 142 and/or metrics 144 for determining (e.g., evaluating) how well the routing service and/or dispatching service utilized by the fleet services platform 130 performs.

In some embodiments, the simulator 110 can run the same simulation (e.g., the same scenario 120) using different fleet services systems and/or different APIs. For example, the simulator 110 can run a first simulation using a first fleet dispatching service for the scenario 120, and the simulator 110 can run a second simulation using a second fleet dispatching service for the same scenario 120, where the second fleet dispatching service is different from the first fleet dispatching service. In another example, the simulator 110 can run two different simulations for a same scenario 120 using two different versions of dispatching service for a same fleet dispatching service provider (e.g., an old version of the dispatching service and a new version of the dispatching service). In some embodiments, the simulation results from the two simulations can be used to generate metrics such that the performance of two different dispatching services (or two different routing services, or two different versions of a same routing or dispatching service) can be compared.

In some embodiments, the simulator 110 may utilize a scenario 120 that is generated based on historical information 154 that includes a plurality of past trips that are completed by vehicles of a fleet that is dispatched and routed by a dispatching engine and a routing engine that is different from the dispatching engine and routing engine used by the fleet services platform 130 in the simulation. In such cases, the metrics may be generated based on the historical information 154 used to generate the scenario 120, and the metrics generated from the simulation results can be compared to the metrics generated based on the historical information 154 in order to provide a comparison between the two dispatching and routing services (e.g., a comparison between the dispatching and routing service used by the fleet of vehicles to complete the past trips and the dispatching and routing service used by the fleet services platform 130 as part of the simulation).

FIGS. 2A-2D illustrate first metrics that are generated based on simulation results from a first simulation that uses On-Demand Transportation Service A and second metrics that are generated based on information regarding simulated or real trips that were completed by On-Demand Transportation Service B that is different from On-Demand Transportation Service A. For example, the second metrics may be generated based on simulation results from a second simulation that uses On-Demand Transportation Service B. In another example, the second metrics may be generated based on historical information 154 that includes past trips that were completed by a fleet of vehicles that are dispatched and routed by On-Demand Transportation Service B.

FIG. 2A illustrates metrics regarding fleet utilization. In this example, the simulation results show that the average (e.g., mean) fleet utilization rate is slightly higher for the first simulation (e.g., the simulation associated with the On-Demand Transportation Service A) compared to the second simulation (e.g., the simulation associated with the On-Demand Transportation Service B).

FIG. 2B illustrates metrics regarding capacity utilization. In this example, the simulation results show that the average (e.g., mean) capacity utilization rate is comparable between the first simulation (e.g., the simulation associated with the On-Demand Transportation Service A) and the second simulation (e.g., the simulation associated with the On-Demand Transportation Service B).

FIG. 2C illustrates metrics regarding wait time (e.g., rider wait time, pick-up wait time). In this example, the simulation results show that the average (e.g., mean) wait time is lower for the first simulation (e.g., the simulation associated with the On-Demand Transportation Service A) compared to the second simulation (e.g., the simulation associated with the On-Demand Transportation Service B).

FIG. 2D illustrates metrics regarding active time (e.g., travel time, trip time). In this example, the simulation results show that the average (e.g., mean) active time is lower for the first simulation (e.g., the simulation associated with the On-Demand Transportation Service A) compared to the second simulation (e.g., the simulation associated with the On-Demand Transportation Service B).

FIGS. 2E-2G illustrate metrics generated based on multiple simulations that are run using the same dispatching and/or routing service with different applied conditions and/or restrictions. The different conditions and/or restrictions include: conditions and specifics as provided by a scenario 120 that is generated based on historical information, the case where the vehicles are traveling at a fixed speed of 15.8 miles per hour, the case where five vehicles of the fleet are traveling at a fixed speed, for the case where ride-pooling (e.g., ride-sharing) is not allowed (e.g., prohibited), for the case where there is 1.7 times more traffic, for the case where there is 1.5 times more traffic, and with regular traffic.

FIG. 2E illustrates metrics for rider on-trip time (e.g., how long a rider spends on a trip), FIG. 2F shows metrics for rider wait time data (e.g., how long a rider waits for a ride), and FIG. 2G shows metrics for fleet utilization rates. In some embodiments, such a comparison can be useful in evaluating the robustness and performance of a dispatching service or routing service in handling various conditions and situations. In some embodiments, such a comparison can also provide insight into ways that a feet manager can include restrictions, rules, and/or conditions to improve various metrics for the fleet. For example, as shown in FIG. 2G, feet utilization is drastically increased when five vehicles of the fleet operate at a fixed speed.

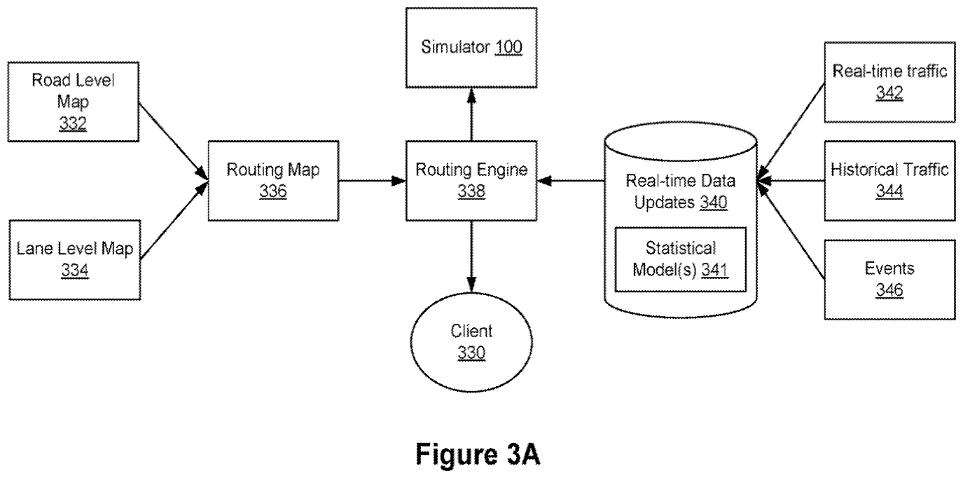

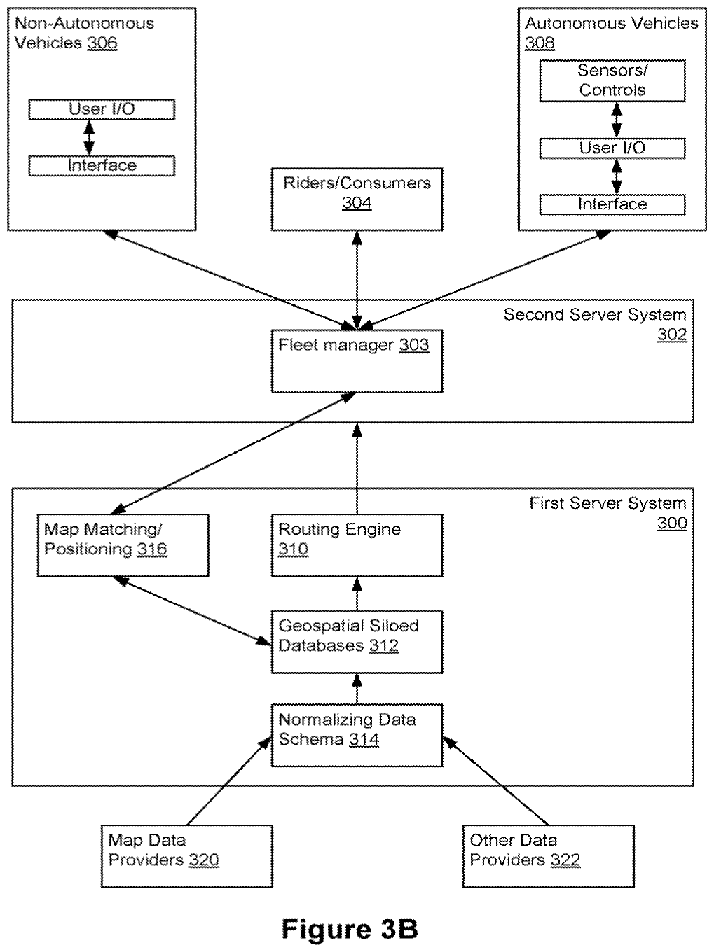

FIGS. 3A-3B are block diagrams illustrating an architecture of a vehicle routing engine, in accordance with some embodiments. For example, the client 330 is the vehicle to be routed by a routing service that is provided by the routing engine. The client 330 may be a non-autonomous vehicle or an autonomous vehicle (or an electronic device associated with the autonomous vehicle).

Real-time data updates 340 include a server system that receives and/or tracks real-time traffic 342, historical traffic 344, and events 346, and includes statistical model(s) 341, and processes and forwards the information to routing engine 338, such that routing engine 338 can create and/or update an ETA for client 330. In some embodiments, the routing engine 338 also uses the information to create and/or update a route for client 330. The routing engine 338 also uses information received from routing map 336 (which may include information from a road level map 332 and/or a lane level map 334) to create/update the route for client 330.

In some embodiments, a simulator 110 may be in communication with the routing engine 338 and use the routing engine 338 to provide routes for a simulation (e.g., a simulated scenario for routing vehicles). In some embodiments, simulation results generated from the simulator 110 are used in generating metrics 144 that can be provided to fleet managers or used for tracking performance of the routing engine 338. Details regarding simulations are provided above with respect to FIGS. 1A-1C, and examples of metrics 144 are provided above with respect to FIGS. 2A-2G.

FIG. 38 illustrates exemplary architecture (e.g., a so-called “stack”) for a fleet of vehicles. The features of the exemplary architecture shown in FIG. 3B may optionally complement, replace, or be combined with the features of the architecture described with respect to FIG. 3A. In some embodiments, the fleet of vehicles is a mixed fleet of vehicles including autonomous vehicles (e.g., autonomous vehicles 308) and non-autonomous vehicles (e.g., non-autonomous vehicles 306). In some circumstances, a fleet includes a mix of different vehicle types (e.g., automobiles, bicycles, scooters, and/or delivery robots). In some circumstances, the fleet provides services to riders (e.g., riders/consumers 304) by transporting riders from a first location to a second location. In some circumstances, the fleet provides services to other consumers, e.g., by delivering items to the consumers (e.g., delivering meals from restaurants, delivering packages from retail stores).

To facilitate the provision of these services using a mixed fleet of vehicles, the stack includes a first server system 300 that provides fleet management services and routing information. The first server system 300 includes one or more processors (e.g., CPUs) and memory storing instructions for the modules described with reference to the first server system (e.g., the map matching/positioning module 316, the routing engine 310, the geospatial siloed databases 312, and the normalizing data schema 314). The first server system 300 interfaces with a fleet manager 303 on a second server system 302. In the exemplary architecture shown in the figure, the second server system 302 acts as a client of the first server system 300, while riders, consumers (e.g., riders/consumers 304), and vehicles (e.g., non-autonomous vehicles 306 and/or autonomous vehicles 308) act as clients of the second server system 302.

In some embodiments, the second server system 302 is a separate and distinct server system from the first server system 300. The second server system 302 includes one or more processors (e.g., CPUs) and memory storing instructions for the modules described with reference to the second server system 302 (e.g., the fleet manager 303). The instructions are executed by the one or more processors. In some circumstances, the fleet manager 303 is one of a plurality of fleet managers serviced by the first server system 300. For example, the fleet manager 303 may be a fleet manager for a specific company's fleet, and the first server system 300 may provide services to multiple companies' fleets.

The first server system 300 includes a routing engine 310 that provides routes, distances, and ETAs for autonomous vehicles 308 and non-autonomous vehicles 306. In some embodiments, a different instance of the routing engine is instantiated for each fleet.

The first server system includes one or more geospatial siloed databases 312 storing geospatial data (e.g., data stored with a corresponding geographical location, such as latitude and longitude). The geospatial siloed databases 312 include map data received from map data providers 320 (e.g., data such as streets locations/geometries, street names). An example of a Map Data Provider is OpenStreetMap. In some embodiments, the geospatial data further includes “high definition” data such as lane-level data (e.g., lane locations/geometries, information about which maneuvers are permitted from which lanes) received from the map data providers 320. The geospatial data further includes data from other data providers 322, such as information received from municipalities about construction and road closures, real-time data, traffic data and other data. In addition, the geospatial siloed databases 312 store locations (e.g., map matched locations) of the vehicles in the various fleets.

In some embodiments, the geospatial siloed databases 312 store a plurality of distinct instances of data covering the same geographical region. For example, the geospatial siloed databases 312 store multiple maps (e.g., with geospatial data overlaid on those maps) covering the same region. In some circumstances, the different maps will include data appropriate to a specific fleet's vehicles (e.g., a fleet will include autonomous vehicles and delivery bots, and the geospatial siloed databases 312 will store one or more maps with information appropriate to the fleet's vehicle types). Some instances of the map may be public to any client (e.g., any fleet manager), while other versions of the map may be private to certain clients (e.g., certain fleet managers). For example, a respective fleet may license data from a respective HD map data provider. The data provided by the respective HD map data provider are thus siloed and private to the respective fleet's fleet manager (e.g., fleet manager 303).

The first server system 300 further includes a map matching/positioning module 316 that matches location data received from vehicles to a map location (e.g., a location of a map stored in the geospatial siloed databases 312). For example, some vehicles generate location data (e.g., GPS data or data from another positioning system, such as GLONASS, Galileo, or BeiDou). In some circumstances, this data is noisy and may place the vehicle away from its actual location, e.g., on a sidewalk or in a building. The map matching/positioning module 316 receives the location data from a respective vehicle (e.g., through the fleet manager 303, which interfaces with the first server system 300), matches the noisy location data to a probable road location and/or lane location and updates the “map matched” location of the vehicle in the geospatial siloed databases 312 (e.g., updates the matched position). In addition, the map matched position is provided to the fleet manager 303 for various purposes (e.g., monitoring the fleet).

As noted above, the stack includes a second server system 302, optionally distinct and separate from the first server system 300. The second server system 360 includes the fleet manager 303, which acts as a client of the first server system 350 (e.g., a client of the routing engine). The fleet manager 303 dispatches vehicles (e.g., non-autonomous vehicles 306 and/or autonomous vehicles 308), assigns routes to vehicles, and assigns staging locations to vehicles within its corresponding fleet (e.g., using information and routes provided by the routing engine). In addition, the fleet manager 303 interfaces with riders/consumers 304 (e.g., via a mobile application on the rider's smartphone or other device). The fleet manager 303 provides information such as ETAs and trip costs to the riders/consumers 304 via their mobile devices. In some embodiments, the fleet manager 303 also receives data such as vehicle positions (e.g., location, including optionally lane-specific location and orientation (e.g., which way the vehicle is pointing)) from the individual vehicles.

In some embodiments, an autonomous vehicle includes an AV platform which serves as an operating system and framework for the autonomous functionality of the autonomous vehicle. The autonomous vehicle includes one or more processors (e.g., CPUs) and memory storing instructions for the modules described with reference to the autonomous vehicle (e.g., the interface module, the AV platform, drivers for the sensors/controls). The instructions are executed by the one or more processors. An example of an AV platform is the open source Robotics Operating System. The fleet manager (e.g., fleet manager 303) interacts with the autonomous vehicles (e.g., autonomous vehicles 308) through an interface module, which is a module that runs on the AV platform to provide routes to the AV platform and receive data from the autonomous vehicle's sensors. For example, in some circumstances, the interface module is provided by the developer of the routing engine to act as a liaison between the first server system and the robotics of the autonomous vehicle. The AV platform receives sensor data from the autonomous vehicles sensor's and, in some circumstances, makes the sensor data available to the fleet manager, which can make the sensor data available further down the stack, for example, to the map matching/position module. In some embodiments, the AV platform sends commands to the autonomous vehicle's controls (e.g., acceleration commands, breaking commands, turning commands, etc.) through a drive-by-wire system.

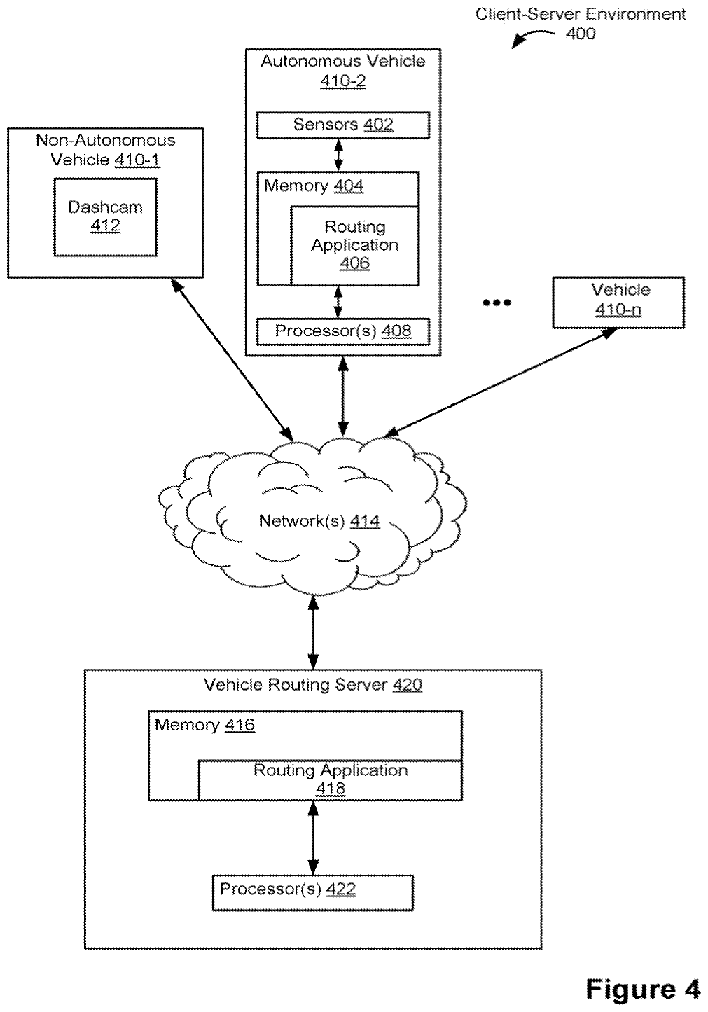

FIG. 4 is a block diagram illustrating a client-server environment, in accordance with some embodiments. The client-server environment 400 includes vehicles 410 (e.g., 410-1, 410-2, . . . , 410-n) that are connected to a vehicle routing server 420 through one or more networks 414. In some embodiments, vehicles 410 are or are analogous to vehicles 306 or 308 (shown in FIG. 3B). In some circumstances, the vehicles 410 operate as clients of vehicle routing server 420. The one or more networks 414 can be any network (or combination of networks) such as the Internet, other Wide Area Networks, Local Area Networks, metropolitan area networks, VPNs, peer-to-peer, ad-hoc connections, and so on.

The non-autonomous vehicle 410-1 is a representative human-driven vehicle (e.g., a car, truck, or motorcycle). In some embodiments, non-autonomous vehicle 410-1 is or is analogous to non-autonomous vehicle 306 (FIG. 3B) In some embodiments, non-autonomous vehicle 410-1 includes a dashboard camera 412 (e.g., a dashcam) that acquires and sends camera images to vehicle routing server 420, which can automatically identify road conditions from dashboard camera images (as well as from autonomous vehicle camera sensor data from autonomous vehicles, such as from sensors 402 in an autonomous vehicle).

The autonomous vehicle 410-2 (e.g., a car, truck, or motorcycle) includes non-transitory memory 404 (e.g., non-volatile memory) that stores instructions for one or more client routing applications 406. In some embodiments, autonomous vehicle 410-2 is or is analogous to autonomous vehicle 308 (FIG. 3B) Client routing applications 406 are executed by one or more processors (e.g., CPUs) 408 on the autonomous vehicle 410-2. In some embodiments, the client routing applications 406 send requests for routes to the vehicle routing server 420 and receive selected routes from the vehicle routing server 420. In some embodiments, the client routing applications 406 direct the autonomous vehicles 410-2 along the selected routes. Client routing applications 406 may be embodied as any appropriate combination of programs, firmware, operating systems, or other logical or physical aspects of the autonomous vehicle 410-2. Autonomous vehicle 410-2 also optionally includes one or more network interfaces and one or more communication buses for interconnecting these components. Autonomous vehicle 410-2 further includes vehicle components, such as an engine/motor, a steering mechanism, lights, signaling mechanisms, etc., some or all of which may be under the control of programs (e.g., a client routing application 406) stored in memory 404.

In some circumstances, a fleet of vehicles e.g., up to vehicle 410-n) is in communication with vehicle routing server 420. The fleet may be a mix of autonomous and human driven vehicles or may be entirely autonomous.

Vehicle routing server 420 includes non-transitory memory 416 (e.g., non-volatile memory) that stores instructions for one or more server routing applications 418 (sometimes referred to as “routing engines”). Vehicle routing server 420 further includes one or more processors (e.g., CPUs) 422 for executing server routing applications 418. Server routing applications 418 may be embodied as any appropriate combination of programs, firmware, operating systems, or other logical or physical aspects of the autonomous vehicle 410-2. Vehicle routing server 420 also optionally includes one or more network interfaces and one or more communication buses for interconnecting these components.

The above-identified applications correspond to sets of instructions for performing functions described herein. The applications need not be implemented as separate software programs, procedures, or modules, and thus various subsets of these instructions may be combined or otherwise re-arranged in various embodiments.

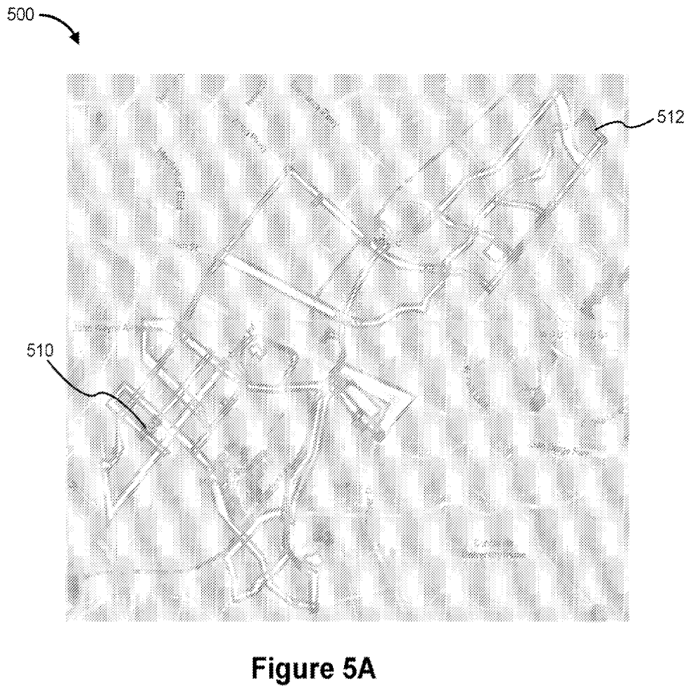

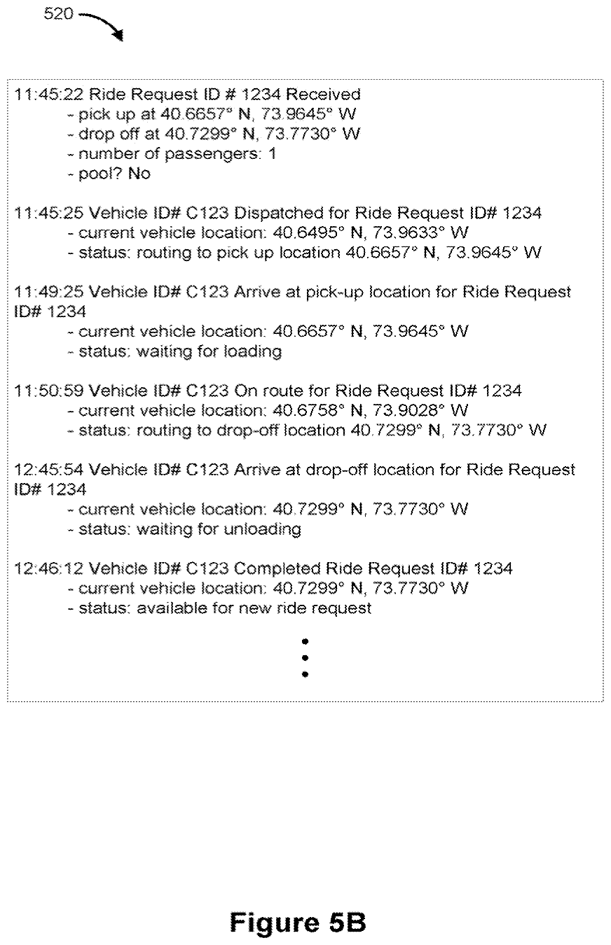

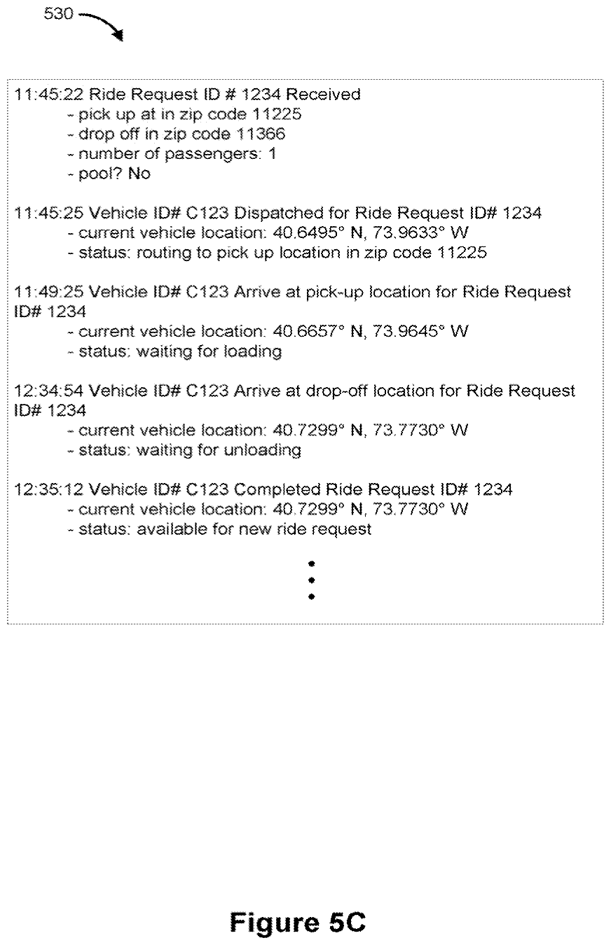

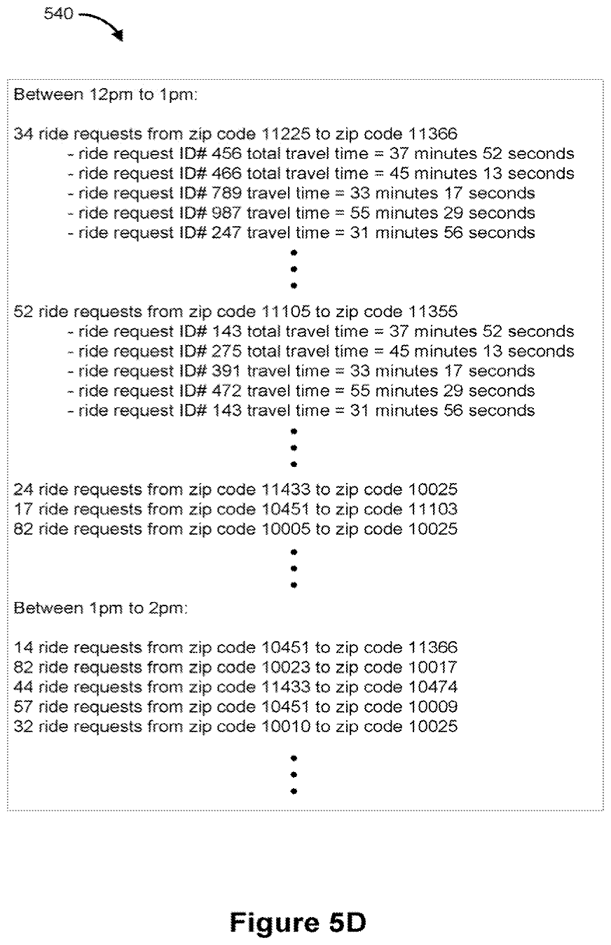

FIGS. 5A-5D illustrate examples of historical information, in accordance with some embodiments.

Referring to FIG. 5A, map 500 illustrates route(s) 512 (e.g., roads) taken by a vehicle 510 over a defined period of time (e.g., over all time, over the last month, on weekend days over the last year). In some embodiments, as shown, the map 500 includes historical information for a specific vehicle (e.g., vehicle 510) of a fleet of vehicles. In some embodiments, the map 500 includes historical information for a fleet of vehicles, which may or may not be a mixed fleet (e.g., having different types of vehicles such as sedans, trucks, autonomous vehicles, non-autonomous vehicles, and/or delivery robots; or having only one type of vehicle, such as only delivery trucks). In some embodiments, a first dispatching service that is configured to dispatch vehicles and/or determine ETAs receives the historical information for a plurality of trips completed by a fleet of vehicles from a second dispatching service that is different from the first dispatching service. The first dispatching service may, for example, receive the historical information for a plurality of trips completed by a fleet of vehicles from a fleet manager of the fleet of vehicles. In some embodiments, the historical information received by the first dispatching service includes information regarding trips that were completed by the fleet of vehicles that were dispatched by the first dispatching service (e.g., the first dispatching service retrieves historical information stored within a computer system associated with the first dispatching service).

In some embodiments, historical information regarding trips completed by vehicle(s) of a fleet of vehicles includes information regarding a pick-up location (e.g., origin), a drop off location (e.g., destination), and the trip time (e.g., how long the trip took and/or and ETA corresponding to the trip). The historical information may include varying levels of detail. For example, historical information that is complete (e.g., a detailed historical information, a comprehensive historical information) may include exact pick up and drop off locations (e.g., street address or GPS coordinates). In another example, historical information that is incomplete (e.g., abbreviated) may include zip codes or areas (e.g., neighborhood identifiers) for pick up and drop off locations. FIG. 5B shows an example of a historical information that is complete and FIGS. 5C and 5D show examples of historical information that is incomplete.

Referring to FIG. 5B, historical information 520 includes complete details regarding completed trips. For example, historical information 520 shows an exact ride request time, a ride request identifier (e.g., identification (ID) number), exact pick-up and drop-off locations, and trip completion time. In this example, the historical information 520 provides detailed information regarding the process of receiving and completing trip requests. The historical information 520 includes a timestamp associated with each task for a trip (e.g., receiving a ride request, dispatching a vehicle for the trip, arriving at the pick-up location), as well as details corresponding to the trip and/or task. For example, the historical information 520 shows that ride request ID #1234 is received at 11:45:22 and that the trip request is for transporting a single passenger from 40.6657° N, 73.9645° W to 40.7299° N, 73.7730° W. The historical information 520 also indicates that this trip request is for a ride-hail trip (not a ride-share or ride-pool trip). The historical information 520 also shows that vehicle ID #C123 is dispatched at 11:45:25, as well as a location of the vehicle at the dispatched time (e.g., at 11:45:25) and a status of the vehicle (e.g., en route to the pick-up location). In some embodiments, the historical information 520 includes an actual time of arrival for the trip. In some embodiments, the historical information 520 also includes information regarding a predicted or estimated time of arrival (ETA) for the trip (e.g., an ETA provided to the user, distinct from the actual time of arrival for the trip). The actual time of arrival may or may not coincide with (e.g., be the same as) the ETA provided by the routing and/or dispatching service. The historical information 520 includes such information for a plurality of completed trips. In some embodiments, historical information that is complete, such as historical information 520, is used to generate a scenario 120 for a simulation.

In contrast to historical information 520, which provides complete and detailed information regarding completed trips, historical information that is incomplete, such as historical information 530 shown in FIG. 5C may include a lower level of detail compared to historical information 520. For example, historical information 530 includes specific times for each task that is performed for a trip request. However, some of the location information is not provided at the same high level of detail as historical information 520. For example, the location information may be a geographical area identifier such as a neighborhood name (e.g., “Upper East Side” or “Queens”) or a zip code. In this example, the vehicle location is provided with specific GPS coordinates and the pick-up and drop-off locations associated with a trip request are provided as zip codes.

FIG. 5D provides another example of historical information 540 that is incomplete, which includes a summary of completed trips. In this example, the historical information 540 does not include exact time stamps for tasks that are performed for each trip, but includes a pick-up zip code, a drop-off zip code, and a total travel time. 10066I In some embodiments, information from historical information that is incomplete, such as historical information 530 or historical information 540, is used to generate a meta-scenario 122. A scenario 120 is generated from the meta-scenario and provided to the simulator 110 for performing a simulation.

In some embodiments, the simulator 110 utilizes a scenario 120 that is generated from historical information (e.g., historical information 520, 530, and 540) to simulate trips such that the scenario 120 is able to reproduce (e.g., recreate) the same conditions that were present when the trip (from the historical information) was actually taken. Thus, a simulation may be used to recreate (e.g., simulate) how trip requests are handled (e.g., dispatched and routed) under conditions of in specific time frame. For example, the simulator 110 may use a scenario 120 corresponding to past trips that were completed on Wednesday Dec. 16, 2020 between Sam and 10 am. In some embodiments, the simulator 110 may be connected to a specific version of the dispatch and/or routing service that was used during Sam and 10 am on Wednesday Dec. 16, 2020, and run the simulation using the specific dispatching and/or routing service. In some embodiments, the simulation may utilize a new version (e.g., current version, updated version) of the dispatching and/or routing service to dispatch and route vehicles for completing trip requests in the simulation. In some embodiments, a same scenario 120 may be used in multiple simulations that use different dispatching and/or routing services (or different versions of the dispatching and/or routing services) in order to provide results for comparing performance between the different dispatching and/or routing services (or different versions of a dispatching and/or routing services).

Any of the formats of historical information described with respect to FIGS. 5A-5D (e.g., complete historical information, incomplete historical information) may be used to generate a scenario 120 or a meta-scenario 122. In some embodiments, the scenario 120 or a meta-scenario 122 may be constructed (e.g., generated) based on both the historical information and environmental information.

In some embodiments, simulations may be used to compare two different modules within a dispatching and/or routing service. For example, the simulator 110 may perform a simulation using a scenario 120 to evaluate the performance of a dispatching and/or routing service One or more modules associated with the dispatching and/or routing service may be updated, such as a module for providing estimated time of arrival (ETAs) for trips. In such cases, a first simulation may be performed using the scenario 120 and an old version of the ETA module, and a second simulation may be performed using the same scenario 120 and a new version of the ETA module. Results (e.g., analytics 140, metrics 144) of the two simulations can be compared to evaluate the performance of the updated ETA module (e.g., new version of the ETA module relative to the original (e.g., old version of the ETA module) In this example, the metrics 144 may include a metric for ETA accuracy where the predicted ETA for a trip is compared with an actual arrival time at a destination for the trip. Using such a metric, improvement in the accuracy in predicting ETAs of a new version of an ETA module over an old version of the ETA module may be demonstrated.

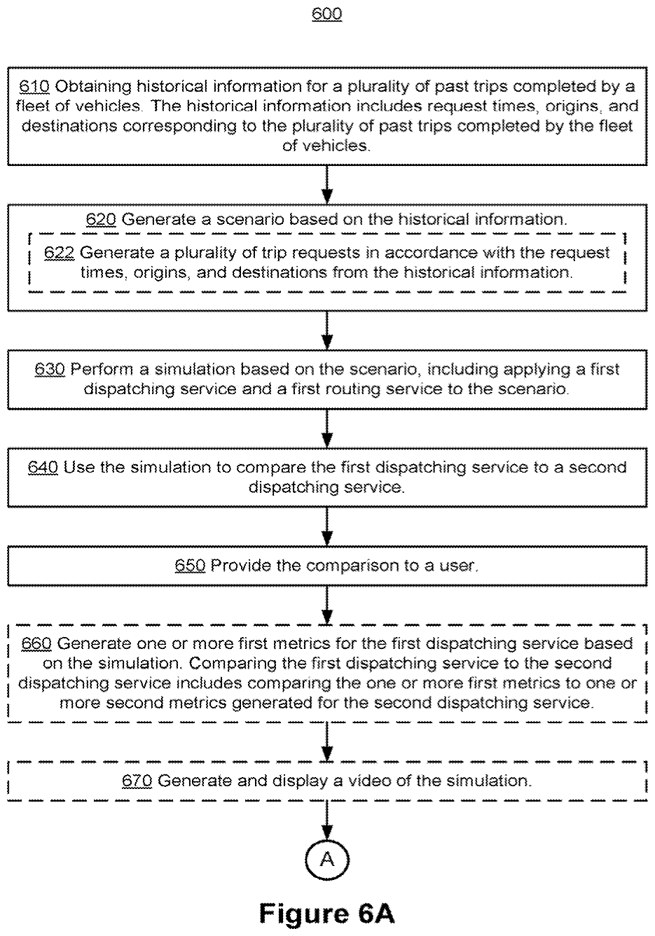

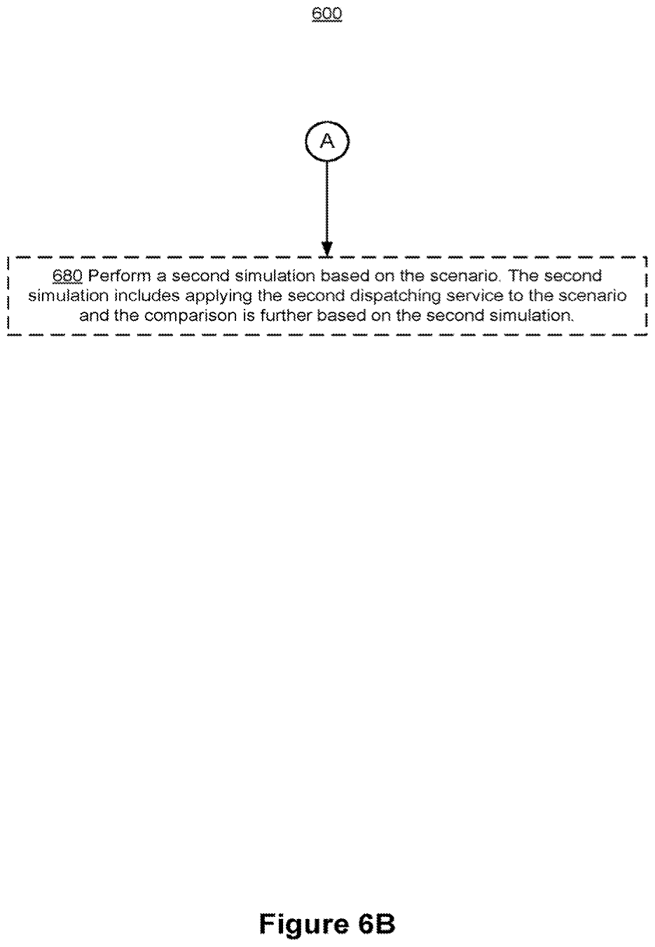

FIGS. 6A-6B illustrate a flowchart of a method 600 for predicting estimated times of arrival based on historical information 154, in accordance with some embodiments. The method 600 includes obtaining (610) historical information 154 (e.g., historical information 520, 530, or 540) for a plurality of past trips completed by a fleet of vehicles. The historical information 154 includes request times, origins, and destinations corresponding to the plurality of past trips completed by the fleet of vehicles. The method 600 further includes generating (620) a scenario 120 based on the historical information 154 and performing (630) a simulation based on the scenario 120. Performing (630) the simulation includes applying a first dispatching service and a first routing service (e.g., a first dispatching service and a first routing service employed by fleet services platform 130) to the scenario 120. The method 600 also includes using (640) the simulation to compare the first dispatching service to a second dispatching service and providing (650) the comparison to a user.

In some embodiments, the simulation is generated for a current time (e.g., in real time, a wall clock time).

In some embodiments, the simulation is generated for a time that is different from a current time. For example, the simulation may be generated using a scenario 120 or environmental conditions (e.g., traffic conditions, weather conditions, road conditions) for a different time (e.g., a past time, such as between 1 pm and 5 pm last Sunday).

In some embodiments, the second dispatching service is an updated version (e.g., new version) of the first dispatching service.

In some embodiments, the second dispatching service is different from the first dispatching service. For example, the first dispatching service may be provided by an fleet services system that is different from another fleet services system that provides the second dispatching service.

In some embodiments, the plurality of past trips that are completed by vehicles of the fleet were dispatched by the second dispatching service. In some embodiments, the plurality of past trips that are completed by vehicles of the fleet were routed by a second routing service. In some embodiments, the second dispatching service is different from the first dispatching service. In some embodiments, the second routing service is different from the first routing service. Alternatively, the second routing service may be the same as the first routing service. For example, the first dispatching and/or routing service may be provided by a different platform or different service provider than the second dispatching and/or routing service. In such cases, using (640) the simulation to compare the first dispatching service to a second dispatching service includes evaluating and comparing the simulation results to information regarding the plurality of past trips provided as historical information 154.

In some embodiments, the historical information 154 includes, for each of the plurality of past trips of the historical information 154, a corresponding request time, a corresponding origin, and a corresponding destination. For example, historical information 520 and 530, shown in FIGS. 5B and 5C, respectively, show a corresponding request time, a corresponding origin, aid a corresponding destination for each trip of the plurality of past trips (e.g., completed past trips) in the historical information 520 and 330.

In some embodiments, the historical information 154 includes one or more of the group consisting of: a vehicle online time, a vehicle offline time, and a vehicle online position.

In some embodiments, generating (620) a scenario 120 based on the historical information 154 includes generating (622) a plurality of trip requests in accordance with the request times, origins, and destinations from the historical information 154.

In some embodiments, generating (620) the scenario 120 includes any of: normalizing the historical information 154, removing (e.g., stripping out, scrubbing out, sanitizing) dispatching decisions and/or routing decisions, removing (e.g., stripping out, scrubbing out, sanitizing) information dispatching decisions and/or routing decisions (such as estimated time of arrival and/or estimated pick up time for a trip).

In some embodiments, the historical information 154 is formatted to comply with one or more consumer privacy constraints and the plurality of trip requests are generated such that the comply with the one or more consumer privacy constraints. For example, a consumer (e.g., an fleet service, such as a ride-hail service or a ride-share service) may provide information regarding past trips that do not include all details and/or all specifics regarding the past trips. FIG. 5D illustrates an example of historical information 540 that includes information regarding completed past trips, where each of the past trips are defined within the consumer privacy constraints of the consumer. In this example, instead of providing the exact location (e.g., global positioning coordinates of the origin and destination) of each past trip, an identifier corresponding to different regions (e.g., zip codes) is provided. Additionally, instead of providing exact trip request times, past trips are clustered or grouped based into specific request time slots (e.g., between 12 pm to 1 pm). In some embodiments, the historical information 154 includes a summation (e.g., summary, digest) of the plurality of past trips. FIG. 5D provides an example of historical information 540 that includes a summation of the plurality of past trips. In some embodiments, historical information 154 (such as historical information 540) that includes a summation (e.g., summary, digest) of the plurality of past trips is used to generate a meta-scenario 122 and a scenario 120 is generated based on (e.g., in accordance with) the meta-scenario 122.

In some embodiments, the method 600 further includes generating (660) one or more first metrics 144 for the first dispatching service based on the simulation. FIGS. 2A-2G illustrate examples of metrics 144 that are generated based on a simulation (e.g., based on simulation results).

In some embodiments, the one or more first metrics 144 include one or more of the group consisting of: wait time, trip time, and vehicle utilization.

In some embodiments, the method 600 also includes generating a first results log 142 based on the simulation (e.g., simulation results), and the one or more first metrics 144 are generated based on the first results log 142. In some embodiments, the method 600 also includes generating a second results log based on the historical information 154, and the one or more second metrics are generated based on the second results log. In some embodiments, using (640) the simulation to compare the first dispatching service to a second dispatching service includes comparing the one or more first metrics to the one or more second metrics.

In some embodiments, the method 600 also includes generating (670) and displaying a video of the simulation. For example, a video of the simulation may be generated based on the information from the results log 142. A screenshot from a video of a simulation is provided with respect to FIG. 1C.

In some embodiments, the plurality of past trips in the historical information 154 were dispatched by the second dispatching service and/or routed by a second routing service. In such cases, using (640) the simulation to compare the first dispatching service to a second dispatching service includes comparing the one or more first metrics to the one or more second metrics so that the performance of the second dispatching and/or routing service that is used by the fleet of vehicles that completed the plurality of past trips in the historical information 154 can be compared to the performance of the first dispatching and/or routing service utilized in the simulation.

In some embodiments, the method 600 also includes performing (670) a second simulation based on the scenario 120. The second simulation includes applying the second dispatching service to the scenario and the comparison is further based on the second simulation.

In some embodiments, the second simulation uses a same scenario 120 as the first simulation.

In some embodiments, the method 600 also includes generating one or more third metrics for the second dispatching service based on the second simulation. In such cases, using (640) the simulation to compare the first dispatching service to a second dispatching service includes comparing the one or more first metrics to the one or more third metrics. In some embodiments, the method 600 also includes generating a third results log based on the second simulation (e.g., second simulation results), and the one or more third metrics are generated based on the third results log.

For example, when the first and second dispatching service correspond to dispatching services that are provided by different service providers, using (640) the simulation to compare the first dispatching service to a second dispatching service includes evaluating and comparing the simulation results that are generated using two different dispatching services (e.g., two different service providers). In another example, when the second dispatching service is an updated (e.g., new) version of the first dispatching and/or routing service, using (640) the simulation to compare the first dispatching service to a second dispatching service includes evaluating and comparing the simulation results that are generated using two versions of a same dispatching and/or routing service.

It will also be understood that, although the terms “first,” “second,” etc. are, in some circumstances, used herein to describe various elements, these elements should not be limited by these terms. These terms are only used to distinguish one element from another. For example, a first vehicle could be termed a second vehicle, and, similarly, a second vehicle could be termed a first vehicle, which changing the meaning of the description, so long as all occurrences of the “first vehicle” are renamed consistently and all occurrences of the second vehicle are renamed consistently. The first vehicle and the second vehicle are both vehicles, but they are not the same vehicle (e.g., the second vehicle is an additional vehicle).

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” is, optionally, construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative embodiments. For purposes of explanation, numerous specific details were set forth in order to provide an understanding of various embodiments of the inventive subject matter. It will be evident, however, to those skilled in the art that embodiments of the subject matter are, optionally, practiced without these specific details. In general, well-known instruction instances, protocols, structures and techniques have not been shown in detail.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best use the embodiments and various embodiments with various modifications as are suited to the particular use contemplated.

1. A method comprising:
obtaining historical information for a plurality of past trips completed by a fleet of vehicles, wherein the historical information includes request times, origins, and destinations corresponding to the plurality of past trips completed by the fleet of vehicles;
generating a scenario based on the historical information;
performing a simulation based on the scenario, wherein the simulation includes applying a first dispatching service and a first routing service to the scenario;
using the simulation to compare the first dispatching service to a second dispatching service; and
providing the comparison to a user.

2. The method of claim 1, further comprising:
generating one or more first metrics for the first dispatching service based on the simulation, wherein comparing the first dispatching service to the second dispatching service includes comparing the one or more first metrics to one or more second metrics generated for the second dispatching service.

3. The method of claim 2, wherein the one or more first metrics include one or more of the group consisting of: wait time, trip time, vehicle utilization.

4. The method of claim 1, wherein:
the plurality of past trips completed by vehicles of the fleet were dispatched by the second dispatching service.

5. The method of claim 1, further comprising:
performing a second simulation based on the scenario, wherein the second simulation includes applying the second dispatching service to the scenario and the comparison is further based on the second simulation.

6. The method of claim 1, wherein the second dispatching service is an updated version of the first dispatching service.

7. The method of claim 1, wherein generating a scenario based on the historical information further comprises:
generating a plurality of trip requests in accordance with the request times, origins, and destinations from the historical information.

8. The method of claim 7, wherein the historical information includes, for each of the plurality of past trips of the historical information, a corresponding request time, a corresponding origin, and a corresponding destination.

9. The method of claim 7, wherein:
the historical information is formatted to comply with one or more consumer privacy constraints; and
the plurality of trip requests are generated such that they comply with the one or more consumer privacy constraints.

10. The method of claim 1, wherein the historical information further includes one or more of the group consisting of: a vehicle online time, a vehicle offline time, and a vehicle online position.

11. The method of claim 1, further comprising:
generating and displaying a video of the simulation.

12. The method of claim 1, wherein the simulation is generated for a current time.

13. The method of claim 1, wherein the simulation is generated for a time that is different from a current time.

14. A computer system, comprising:
one or more processors; and
memory storing one or more programs, the one or more programs storing instructions that, when executed by the one or more processors, cause the one or more processors to perform a method comprising:
obtaining historical information for a plurality of past trips completed by a fleet of vehicles, wherein the historical information includes request times, origins, and destinations corresponding to the plurality of past trips completed by the fleet of vehicles;
generating a scenario based on the historical information;
performing a simulation based on the scenario, wherein the simulation includes applying a first dispatching service and a first routing service to the scenario;
using the simulation to compare the first dispatching service to a second dispatching service; and
providing the comparison to a user.

15. A non-transitory computer readable storage medium storing instructions that, when executed by a computer system having one or more processors, cause the computer system to perform a method comprising:
obtaining historical information for a plurality of past trips completed by a fleet of vehicles, wherein the historical information includes request times, origins, and destinations corresponding to the plurality of past trips completed by the fleet of vehicles;
generating a scenario based on the historical information;
performing a simulation based on the scenario, wherein the simulation includes applying a first dispatching service and a first routing service to the scenario;
using the simulation to compare the first dispatching service to a second dispatching service; and
providing the comparison to a user.

16. The computer system of claim 14, wherein the instructions cause the one or more processors to perform the method, further comprising:
generating one or more first metrics for the first dispatching service based on the simulation, wherein comparing the first dispatching service to the second dispatching service includes comparing the one or more first metrics to one or more second metrics generated for the second dispatching service, wherein the one or more first metrics include one or more of the group consisting of: wait time, trip time, vehicle utilization.

17. The computer system of claim 14, wherein the plurality of past trips completed by vehicles of the fleet were dispatched by the second dispatching service.

18. The computer system of claim 14, wherein the instructions cause the one or more processors to perform the method, further comprising:
performing a second simulation based on the scenario, wherein the second simulation includes applying the second dispatching service to the scenario and the comparison is further based on the second simulation.

19. The computer system of claim 14, wherein the second dispatching service is an updated version of the first dispatching service.

20. The computer system of claim 14, wherein generating a scenario based on the historical information further comprises:
generating a plurality of trip requests in accordance with the request times, origins, and destinations from the historical information.
